(19) United States
(12) Patent Application Publication
(10) Pub. No.: US 2006/0056431 A1
(43) Pub. Date: Mar. 16, 2006

(54) Communication terminal

(75) Inventors: Manabu Toyoda, Kawasaki (JP); Yoshihiro Ando, Sapporo (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/022,776

(22) Filed: Dec. 28, 2004

(30) Foreign Application Priority Data
Sep. 14, 2004 (JP) 2004-266527

(51) Int. Cl. H04L 12/28

(52) U.S. Cl. 370/402; 370/352

(57) ABSTRACT

A control-information receiving unit receives first control information including information relating to an e-mail from a mail server. A control-information transmitting unit transmits either of the second control information relating to a request for setting a communication path and third control information relating to a rejection of communication to the mail server. When it is determined to permit the reception of the e-mail based on the information relating to the e-mail, the control-information transmitting unit transmits the second control information to the mail server; and when it is determined to reject the reception of the e-mail the control-information transmitting unit transmits the third control information to the mail server.

### BACKGROUND OF THE INVENTION

1) Field of the Invention

The present invention relates to a communication terminal that, when first control information according to a reception preparation request for an electronic mail (e-mail) has been received from a mail server, transmits second control information according to a communication path set request to the mail server, and receives the e-mail via a communication path set by the mail server. More particularly the present invention relates to the communication terminal that enables a user thereof to select whether to permit the communication terminal to receive an e-mail that is sent to him/her, without having to pay communication fees.

2) Description of the Related Art

Recently, there is a wide proliferation of mobile telephones functioning as communication terminals that are capable not only of audio communication, but also of receiving and transmitting e-mails. This proliferation of communication terminals having functions for receiving/transmitting e-mail has been accompanied by a problem of receiving junk mails.

Junk mails are e-mails transmitted by businesses for the purpose of advertising products and services. The e-mails are sent to users of the communication terminals even though they do not wish to receive them, and for this reason are generally termed junk mails.

An electronic system has been disclosed that aims to prevent this type of junk mails by registering e-mail addresses of senders who are to be blocked in a mail server beforehand, and terminating transmission of an e-mail when the e-mail address of its sender matches one of the registered senders' e-mail addresses (see, for example, Japanese Patent Application Laid-open No. 2002-57807 and Japanese Patent Application Laid-open No. 2003-32308, respectively).

To omit the procedure of registering e-mail addresses in the mail server, an e-mail system has been disclosed that determines whether to permit or reject reception of e-mails on the mobile telephone side (see, for example, Japanese Patent Application Laid-open No. 2003-337779). In this e-mail system, the mobile telephone receives header information of the e-mail from the mail server, and determines whether to permit or reject reception of the main text of the e-mail based on sender e-mail address information contained in the header information.

However, the conventional technique disclosed in the Japanese Patent Application Laid-open Nos. 2002-57807 and Japanese Patent Application Laid-open No. 2003-337779 has a problem that users of the mobile telephones incur communication fees for registering senders' e-mail addresses that are to be blocked at the mail server, and for receiving mail header information from the mail server.

Specifically, in data communications using the mobile telephone, the user is billed communication fees according to the amount of transmitted and received data. In registering senders' e-mail addresses in the conventional technique of the Japanese Patent Application Laid-open No. 2002-57807 and Japanese Patent Application Laid-open No. 2003-32308, data is transmitted and received between the mobile telephone and the mail server, and therefore, the user incurs communication fees.

In the conventional technique of the Japanese Patent Application Laid-open No. 2003-337779, although receiving mail header information results in smaller communication fees than receiving the entire data of the e-mail, the user must still pay communication fees.

Accordingly, if the user of the mobile telephone can select whether to permit/reject reception of e-mails transmitted to him/her without having to pay communication fees, this will benefit not only the users but also the businesses who provide e-mail services, since it will increase the number of people who sign on for their services.

### SUMMARY OF THE INVENTION

It is an object of the present invention to solve at least the above problems in the conventional technology.

A communication terminal according to one aspect of the present invention, which transmits, upon receiving first control information relating to a request for preparing a reception of an e-mail from a mail server, second control information relating to a request for setting a communication path to the mail server, and receives the e-mail via the communication path set by the mail server, includes a control-information receiving unit that receives the first control information from the mail server, the first control information including information relating to the e-mail; and a control-information transmitting unit that transmits either of the second control information and third control information relating to a rejection of communication to the mail server. When it is determined to permit the reception of the e-mail based on the information relating to the e-mail, the control-information transmitting unit transmits the second control information to the mail server; and when it is determined to reject the reception of the e-mail the control-information transmitting unit transmits the third control information to the mail server.

A communication terminal according to another aspect of the present invention, which transmits control information relating to a request for setting a communication path to a mail server that determines whether to permit a transmission of an e-mail, and transmits the e-mail via the communication path set by the mail server, includes a control-information creating unit that creates the control information including either of information relating to an e-mail to be permitted and information relating to an e-mail to be rejected; and a control-information transmitting unit that transmits the control information created to the mail server.

A communication method according to still another aspect of the present invention, which is for, upon receiving first control information relating to a request for preparing a reception of an e-mail from a mail server, transmitting second control information relating to a communication path setting request to the mail server, and receiving the e-mail via the communication path set by the mail server, includes creating the first control information including information relating to the e-mail at the mail server; transmitting the first control information created from the mail server; receiving the first control information from the mail server; and transmitting either of the second control information and third control information relating to a rejection of communication to the mail server. When it is determined to permit the reception of the e-mail based on the information relating to the e-mail, the transmitting either of the second control information and third control information includes transmitting the second control information to the mail server; and when it is determined to reject the reception of the e-mail the control-information transmitting unit the transmitting either of the second control information and third control information includes transmitting the third control information to the mail server.

A communication method according to still another aspect of the present invention, which is for, when a communication terminal transmits control information relating to a request for setting a communication path to a mail server that determines whether to permit a transmission of an e-mail, transmitting the e-mail via the communication path set by the mail server, includes creating the control information including either of information relating to an e-mail to be permitted and information relating to an e-mail to be rejected; transmitting the control information created to the mail server; and determining whether to permit a transmission of the e-mail to the communication terminal based on either of the information relating to the e-mail to be permitted and the information relating to the e-mail to be rejected.

A computer-readable recording medium according to still another aspect of the present invention stores communication programs that cause a computer to execute the above communication methods according to the present invention.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a diagram of the concept of reception permit/reject processing of e-mail according to a first embodiment of the present invention;

FIG. 2 is a function block diagram of the functional constitution of a radio communication system shown in FIG. 1;

FIG. 3 is an example of control information that contains e-mail information;

FIG. 4 is a function block diagram of the functional constitution of a mobile telephone shown in FIG. 1;

FIG. 5 is an example of reception permit/reject determining conditions shown in FIG. 4;

FIG. 6 is an example of an e-mail information output screen that outputs e-mail information;

FIG. 7 is a flowchart (1) of a process procedure for receive/reject processing of an e-mail according to the first embodiment;

FIG. 8.is a flowchart (2) of a process procedure for receive/reject processing of an e-mail according to the first embodiment;

FIG. 9 is a flowchart of a process procedure for reception permit/reject determination processing shown in FIG. 7;

FIG. 10 is a diagram of the hardware constitution of a connection control apparatus shown in FIG. 2;

FIG. 11 is a diagram of the hardware constitution of a mobile telephone shown in FIG. 4;

FIG. 12 is an example of an e-mail information output screen that is output when the control information is saved;

FIG. 13 is a diagram of the concept of reception permit/reject selection processing of an e-mail according to a second embodiment;

FIG. 14 is a function block diagram of the functional constitution of a radio communication system shown in FIG. 13; and

FIG. 15 is a diagram of the functional constitution of a mobile telephone shown in FIG. 13.

### DETAILED DESCRIPTION

Exemplary embodiments of a communication terminal according to the present invention will be explained below in detail with reference to the accompanying drawings. In the embodiments below, there will be explained cases that the communication terminal for receiving e-mails is a mobile telephone.

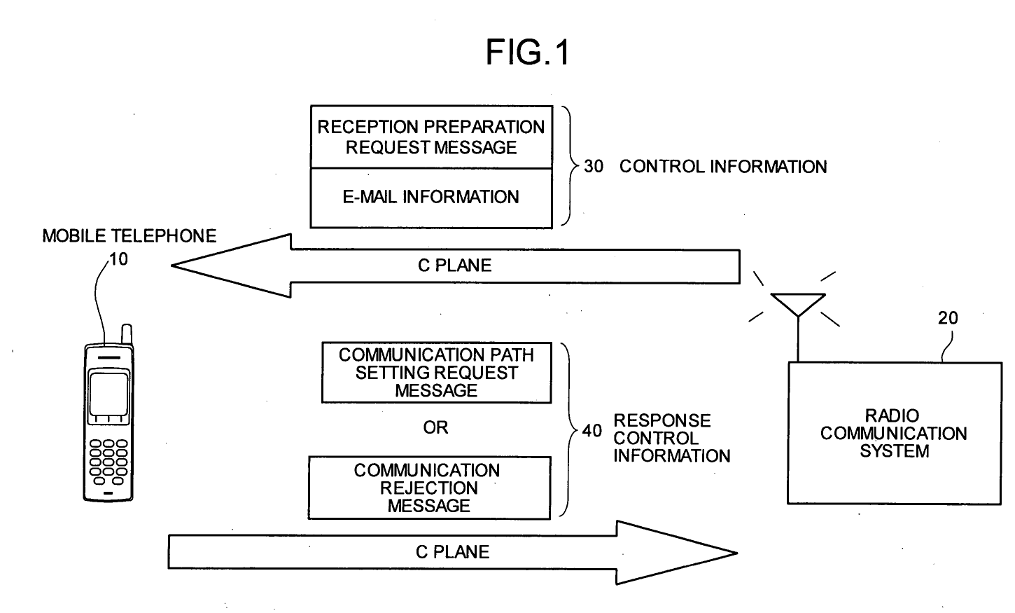

FIG. 1 is a diagram of the concept of reception permit/reject processing of e-mail according to a first embodiment of the present invention. As shown in FIG. 1, in reception permit/reject processing, control information for controlling communications between a mobile telephone 10 and a radio communication system 20 is transmitted via a control plane (C plane).

The radio communication system 20 is a communication system that, when it receives an e-mail addressed to the user of the mobile telephone 10 via a network such as the Internet, temporarily stores the e-mail, sets a communication path to the mobile telephone 10, and transmits the e-mail to the mobile telephone 10.

A control (C) plane is a pseudo communication line that transmits control information for connecting communications between the mobile telephone 10 and the radio communication system 20. Packet data of e-mails and the like, and audio data when communicating via the mobile telephone, are transmitted on a pseudo communication line termed a user plane (U plane).

In mobile telephone communication services today, users are billed communication fees corresponding to the amount of data transmitted on the U plane, while control information transmitted on the C plane does not incur communication fees.

Accordingly, the radio communication system 20 appends information relating to the e-mail, such as the e-mail address of its sender, a mail subject (title), an outline of its main text, and the like, to a reception preparation request message, which comprises existing control information, as e-mail information, creates control information 30 that includes the e-mail information, and transmits the control information 30 via a C plane that does not incur communication fees.

The reception preparation request message is control information that requests the mobile telephone 10 to start preparing to receive an e-mail, received by the radio communication system 20 and addressed to the user of the mobile telephone 10.

For example, in general packet radio service (GPRS) standards, being a data transmission system of the mobile telephone 10, a request packet data protocol (PDP) context activation message corresponds to the reception preparation request message.

The user of the mobile telephone 10 receives the control information 30, and determines whether to permit/reject reception of the e-mail based on the e-mail information included in the control information 30. The mobile telephone 10 transmits response control information 40, which includes a communication path setting request message or a communication rejection message of the result that is determined by the user, to the radio communication system 20 via the C plane.

The communication path setting request message is a message that requests the setting of a communication path between the mobile telephone 10 and the radio communication system 20. In GPRS standards, the communication path setting request message corresponds to an activate PDP context request message.

The communication rejection message is a message that rejects the request to start reception preparation made by the reception preparation request message, and, in GPRS standards, corresponds to a request PDP context activation reject message.

When the radio communication system 20 receives a communication path setting request message from the mobile telephone 10, it sets a communication path between itself and the radio communication system 20, and transmits the e-mail to the mobile telephone 10. On the other hand, when a communication rejection message is received from the mobile telephone 10, the radio communication system 20 discards the e-mail addressed to the user of the mobile telephone 10.

In this way, when the radio communication system 20 receives an e-mail addressed to the user of the mobile telephone 10, it sends the control information 30 containing the e-mail information to the mobile telephone 10. When the mobile telephone 10 determines to permit reception of the e-mail based on the e-mail information included in the control information 30, it transmits the response control information 40 containing the communication path setting request message to the radio communication system 20, when the mobile telephone 10 determines to reject reception of the e-mail, it transmits the response control information 40 containing the communication rejection message to the radio communication system 20. This enables the user to select whether to permit the e-mail without incurring communication fees.

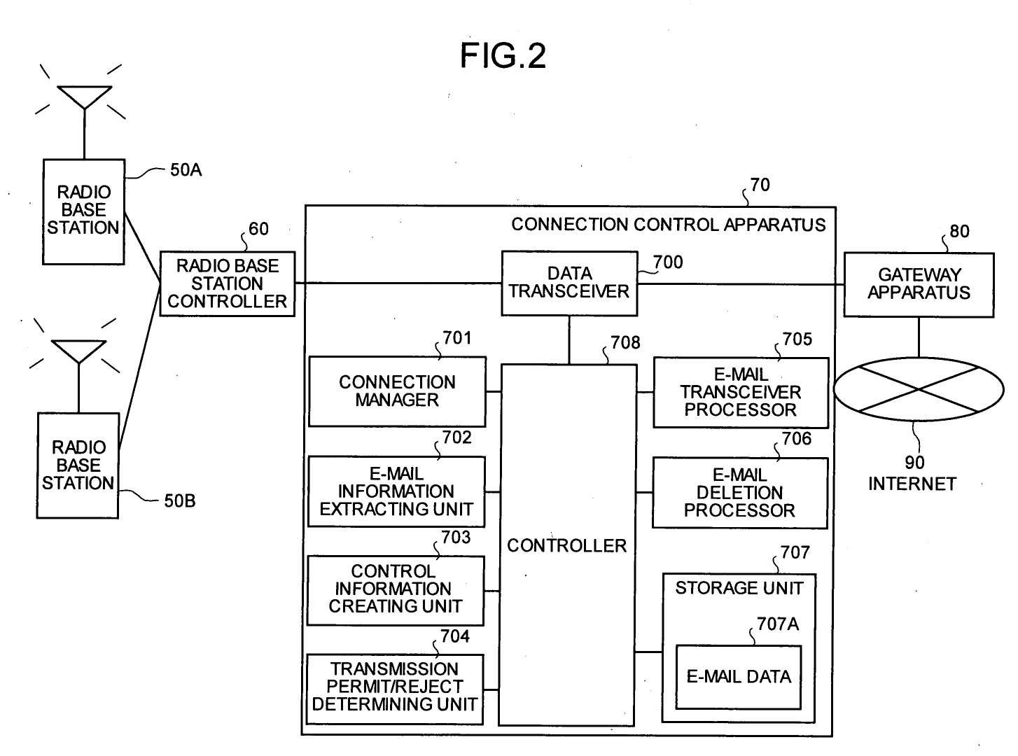

FIG. 2 is a block diagram of the functional constitution of the radio communication system 20 shown in FIG. 1. As shown in FIG. 2, the radio communication system 20 includes radio base stations 50a and 50b, a radio base station controller 60, a connection control apparatus 70, and a gateway apparatus 80.

The radio base stations 50a and 50b transmit and receive data by radio to/from the mobile telephone 10. The radio base station controller 60 is an apparatus that allocates radio channels, and switches the communication channel when the mobile telephone 10 has moved from a communication area of the radio base station 50a (or 50b) to a communication area of the radio base station 50b (or 50a).

The connection control apparatus 70 is a mail server that exchanges control information with the mobile telephone 10, establishes and cuts off communications and the like, and transmits/receives e-mails to/from the mobile telephone 10.

The connection control apparatus 70 not only controls communication connections and transmits/receives e-mails, but also transmits the control information 30 containing the e-mail information via a C plane to the mobile telephone 10 when an e-mail addressed to the user of the mobile telephone 10 is received.

The connection control apparatus 70 then performs processing to receive the response control information 40, indicating whether to permit or reject the communication connection, from the mobile telephone 10, and to determine whether to permit or reject transmission of the e-mail to the mobile telephone 10 based on the response control information 40.

The connection control apparatus 70 includes a data transceiver 700, a connection manager 701, an e-mail information extracting unit 702, a control-information creating unit 703, a transmission permit/reject determining unit 704, an e-mail transceiver processor 705, an e-mail deletion processor 706, a storage unit 707, and a controller 708.

The data transceiver 700 transmits/receives control information and e-mails to/from the radio base station controller 60 and the gateway apparatus 80, explained later. The connection manager 701 manages establishment and cutoff of communication connections with the mobile telephone 10.

Specifically, the connection manager 701 manages communication connection with the mobile telephone 10 by exchanging control information, for establishing and cutting-off communications thereto, with the mobile telephone 10.

When the connection control apparatus 70 receives an e-mail addressed to the user of the mobile telephone 10, the connection manager 701 extracts the control information 30 containing the e-mail information from the control-information creating unit 703 explained later, and transmits the control information 30 to the mobile telephone 10.

When an e-mail addressed to the user of the mobile telephone 10 is received, the e-mail information extracting unit 702 extracts e-mail information from it, such as the address of the sender of the e-mail, its subject (title), an outline of its main text, and the like. The outline of the e-mail is an abstract, created from the main text of the e-mail by using a conventional text abstraction technique.

The control-information creating unit 703 creates the control information 30 by appending the e-mail, extracted by the e-mail information extracting unit 702, to the reception preparation request message for requesting that the mobile telephone 10 prepare for a communication.

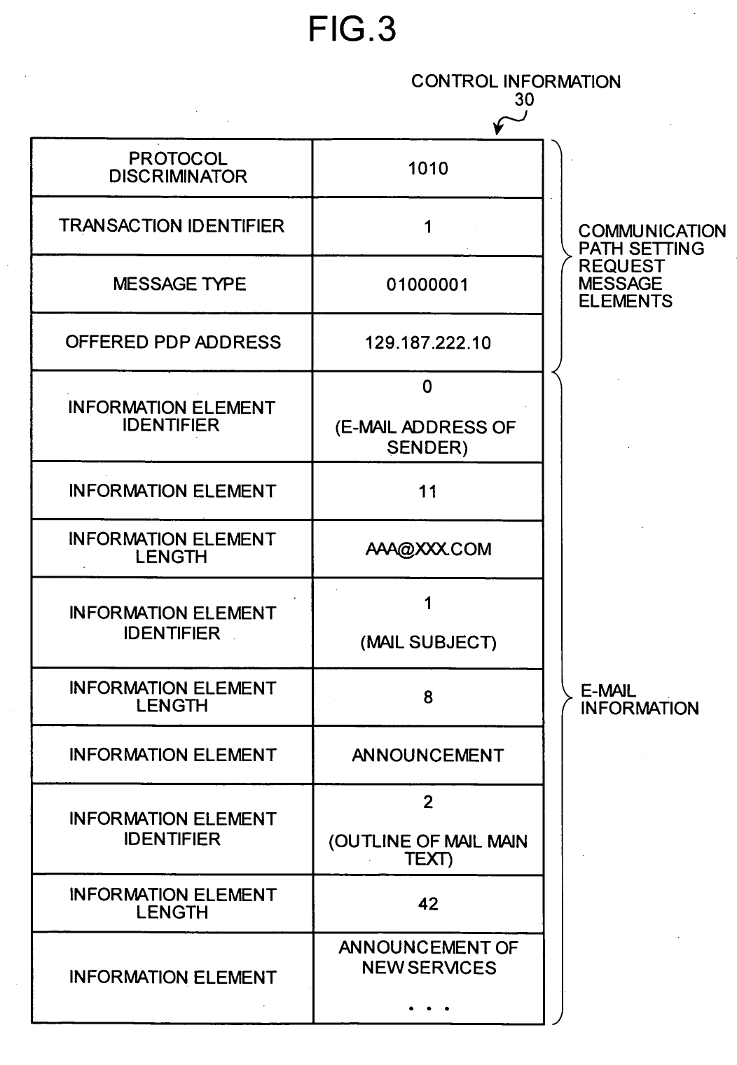

FIG. 3 is an example of the control information 30 that contains e-mail information. The control information 30 contains a protocol discriminator, a transaction identifier, a message type, an offered PDP address, information element identifiers, information element lengths, and information elements.

The protocol discriminator is an identification number for identifying types of control information. In the example of FIG. 3, the protocol discriminator is “1010”, signifying that this control information is transmitted in order to send a packet communication.

The transaction identifier is an identification number, allocated to each piece of control information. An identification number that uniquely corresponds to the transaction identifier of the control information, sent in response to the transmitted control information, is allocated thereto, enabling the relationship between the control information to be confirmed.

In the example of FIG. 3, the transaction identifier is “1”, and “9” is allocated to the transaction identifier of the control information that is transmitted in response to the constitution shown in FIG. 3. The same values are used for these transaction identifiers unless their names change.

The message type is an identification number that identifies the content of the control information, whose type is specified by the protocol discriminator. In the example of FIG. 3, the message type is “01000001”, signifying that this control information is a reception preparation request message.

The offered PDP address is information relating to an address that is temporarily allocated to the mobile telephone 10 in order to identify it at the time of a communication. In the example of FIG. 3, an address “129.187.222.10” is allocated to the mobile telephone 10.

When the control information contains e-mail information, the information element identifier identifies the type of the e-mail information. The information element length is information relating to the data length of the e-mail information contained in the control information. The information element is the content of the e-mail information contained in the control information.

In the example of FIG. 3, there are three types of information element identifiers “0”, “1”, and “2”, “0” corresponding to the e-mail address of the sender of the e-mail, “1” corresponding to the mail subject (title) of the e-mail, and “2” corresponding to information relating to an outline of the main text of the e-mail.

The e-mail address of the sender of the e-mail has an information element length of “11” bytes and an information element of “aaa@xxx.com”, the subject of the e-mail has an information element length of “8” bytes and its information element is “announcement”, the outline of the e-mail has an information element length of “42” bytes and its information element is “announcement of new services for . . . ”

The information relating to the protocol discriminator, the transaction identifier, the message type, and the offered PDP address, are contained in a conventional reception preparation request message. According to the first embodiment, the information element identifier, the information element length, and the information element, are also appended to the reception preparation request message to create the control information 30.

Referring back to FIG. 2, the transmission permit/reject determining unit 704 transmits the control information 30 containing the e-mail information to the mobile telephone 10, and receives the response control information 40 from the mobile telephone 10 in accordance therewith.

The transmission permit/reject determining unit 704 determines whether the response control information 40 is a communication path setting request message or a communication rejection message, and determines whether to transmit the e-mail to the mobile telephone 10.

The e-mail transceiver processor 705 receives e-mails from the mobile telephone 10, and transfers them to the gateway apparatus 80. The e-mail transceiver processor 705 also receives e-mails via the Internet 90, and stores them in the storage unit 707.

When the transmission permit/reject determining unit 704 determines to send an e-mail to the mobile telephone 10, the e-mail transceiver processor 705 reads the data of the e-mail from the storage unit 707 and transmits it to the mobile telephone 10.

When the transmission permit/reject determining unit 704 determines not to send the e-mail to the mobile telephone 10, the e-mail deletion processor 706 deletes the data of the e-mail from the storage unit 707.

The storage unit 707 is a storage device such as a hard disk apparatus, which stores e-mails that are transmitted and addressed to the user of the mobile telephone 10, and e-mails transmitted from the mobile telephone 10, as e-mail data 707a. The controller 708 controls the entire connection control apparatus 70, such as transmission/reception of data between its functional units.

The gateway apparatus 80 is an apparatus that transmits and receives data, and uses protocol conversion and the like to eliminate differences in communication protocols of the Internet 90 and the network that connects the radio base stations 50a and 50b, the radio base station controller 60, and the connection control apparatus 70.

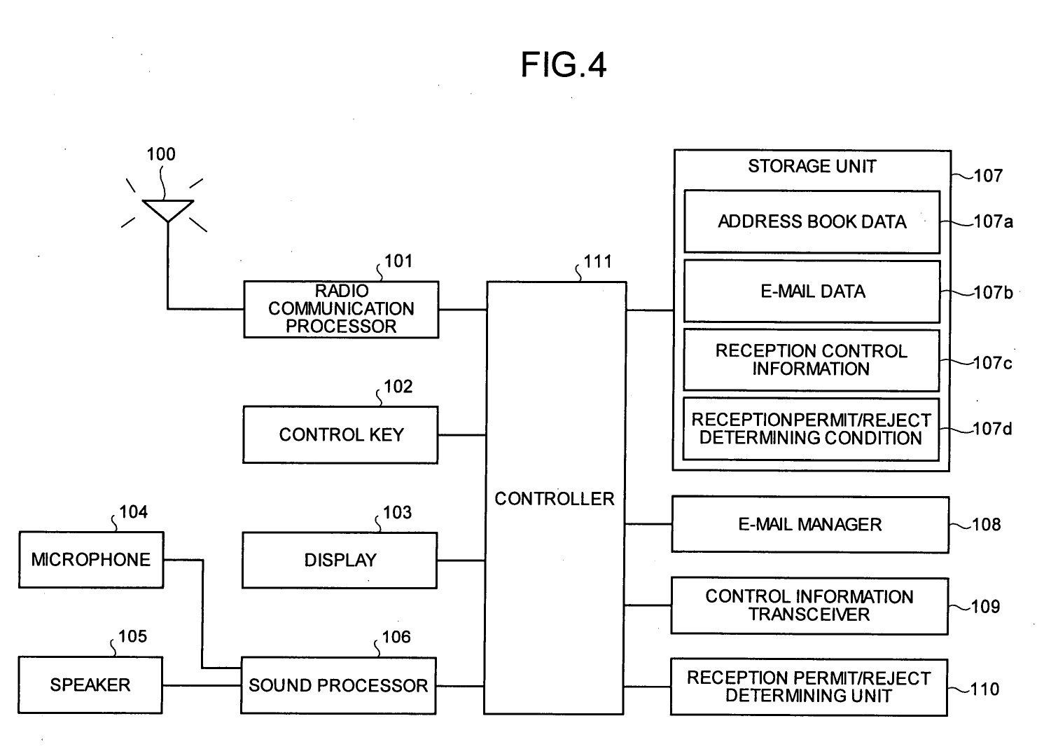

FIG. 4 is a function block diagram of the functional constitution of the mobile telephone 10 shown in FIG. 1. As shown in FIG. 4, the mobile telephone 10 includes an antenna 100, a radio communication processor 101, control keys 102, a display 103, a microphone 104, a speaker 105, a sound processor 106, a storage unit 107, an e-mail manager 108, a control information transceiver 109, a reception permit/reject determining unit 110, and a controller 111.

The antenna 100 emits and receives electric waves. The radio communication processor 101 is an integrated circuit that performs processing such as creating electric waves to be emitted from the antenna 100, reconstructing communication data from electric waves that are received by the antenna 100, and the like.

The control keys 102 are buttons for inputting text and numbers. The display 103 is a liquid crystal display that displays various pieces of information. The microphone 104 inputs a sound, and the speaker 105 outputs the sound, during telephone communication.

The sound processor 106 controls sound processing during telephone communication. Specifically, the sound processor 106 transmits audio data, input through the microphone 104, to the radio communication processor 101, and requests the radio communication processor 101 to convert the audio data to electric waves for emission. The sound processor 106 extracts audio data, reconstructed from received waves by the radio communication processor 101, and outputs it to the speaker 105.

The storage unit 107 is a storage device such as a flash memory. The storage unit 107 stores address book data 107a, e-mail data 107b, reception control information 107c, and reception permit/reject determining conditions 107d.

The address book data 107a includes individual information, such as telephone numbers and e-mail addresses, which are referred to during telephone communication or when sending an e-mail. The e-mail data 107b is data relating to e-mails that are previously received by the mobile telephone 10.

The reception control information 107c contains control information 30 transmitted by the connection control apparatus 70. The reception permit/reject determining conditions 107d are determining conditions, referred to when the mobile telephone 10 is set to automatically determine whether to permit reception of e-mails without inquiring the user.

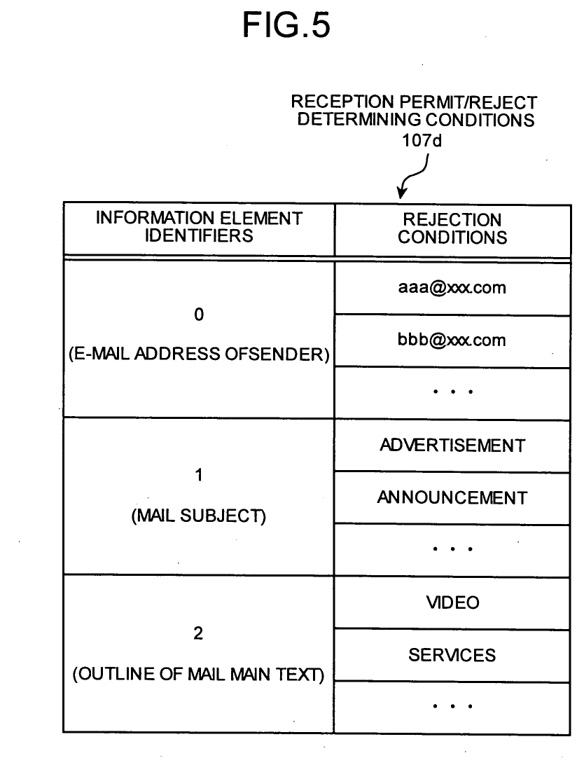

FIG. 5 is an example of the reception permit/reject determining conditions 107d shown in FIG. 4. As shown in FIG. 5, the reception permit/reject determining conditions 107d contain information element identifiers and rejection conditions.

The information element identifiers are the same as those shown in FIG. 3, and identify items that the rejection conditions are applied to. The rejection conditions define conditions for rejecting e-mails.

In the example of FIG. 5, the information element identifier of “0” (i.e. the e-mail address of the sender) has rejection conditions such as “aaa@xxx.com”, bbb@xxx.com, and the like. Therefore, when the e-mail address of the sender is “aaa@xxx.com”, bbb@xxx.com, or the like, the e-mail is rejected.

The information element identifier of “1” (mail subject) has rejection conditions such as “advertisement”, “announcement”, and the like. Therefore, e-mails having subjects such as “advertisement”, “announcement”, and the like, are rejected.

The information element identifier of “2” (outline of the main text of the mail) has rejection conditions such as “video”, “services”, and the like. Therefore, e-mails having words such as “video”, “services”, and the like, in their main text outlines are rejected.

Referring back to FIG. 4, the e-mail manager 108 manages creation, transmission/reception, and the like, of e-mails. The control information transceiver 109 transmits/receives control information relating to communication control to/from the connection control apparatus 70. When the control information transceiver 109 receives the control information 30 containing e-mail information, it transmits the response control information 40, which indicates whether to permit the data communication, to the connection control apparatus 70.

When the setting is such that the user determines whether to permit/reject reception of e-mails addressed to him/her each time they are transmitted, the reception permit/reject determining unit 110 obtains e-mail information that contains the control information 30 received by the control information transceiver 109, and outputs the obtained e-mail information to the display 103.

The reception permit/reject determining unit 110 then receives the selection made by the user, indicating whether he/she permits reception of the e-mail that corresponds to the e-mail information. When he/she permits it, the reception permit/reject determining unit 110 requests that the control information transceiver 109 send a communication path setting message. When the user does not permit the e-mail, the reception permit/reject determining unit 110 requests that the control information transceiver 109 send a communication rejection message.

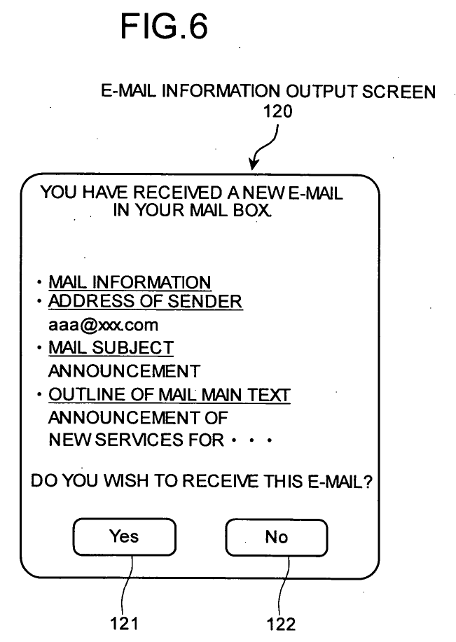

FIG. 6 is an example of an e-mail information output screen 120 that outputs e-mail information. As shown in FIG. 6, the e-mail information output screen 120 outputs the sender's e-mail address, the mail subject, and the outline of the main text, in addition to input buttons 121 and 122, which are used in selecting whether to permit reception of the e-mail.

When permission/rejection for reception of e-mails is set to be automatically determined based on conditions stored in the reception permit/reject determining conditions 107d, the reception permit/reject determining unit 110 determines, whether to permit reception by using a method such as that described in FIG. 5.

Having determined to permit an e-mail, the reception permit/reject determining unit 110 then requests the control information transceiver 109 to transmit a communication path setting request. Having determined not to permit an e-mail, the reception permit/reject determining unit 110 requests the control information transceiver 109 to transmit a communication rejection message.

The controller 111 controls the entire mobile telephone 10, overseeing reception/transmission of various types of data between its functional units, and the like.

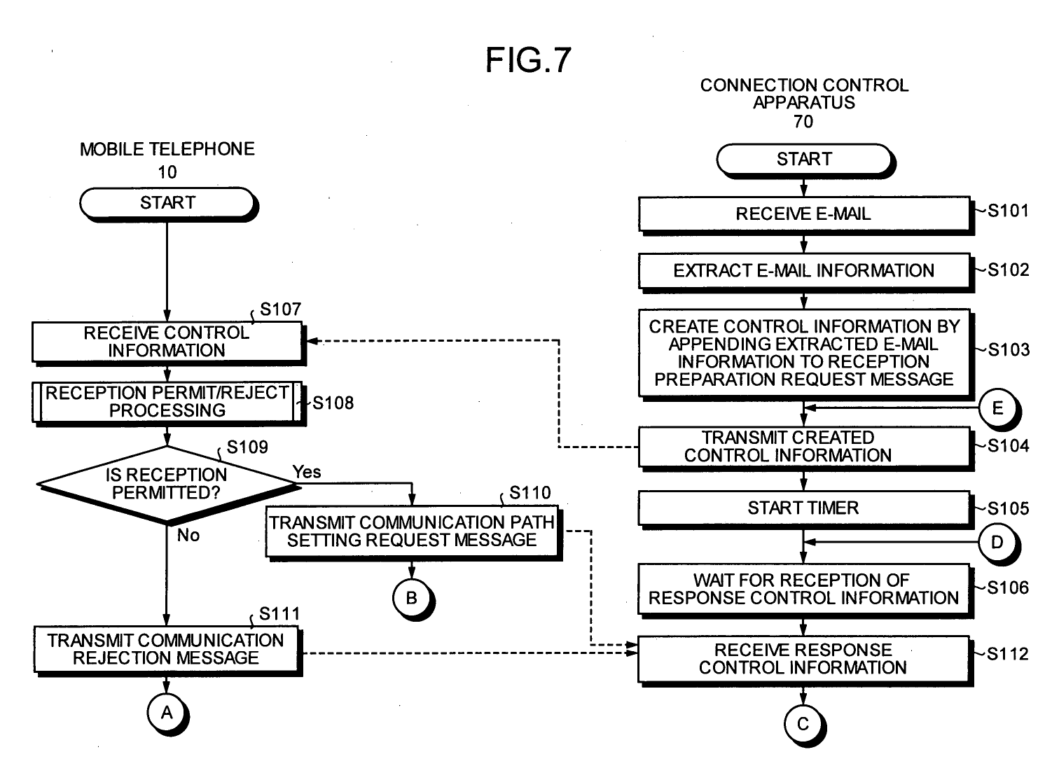

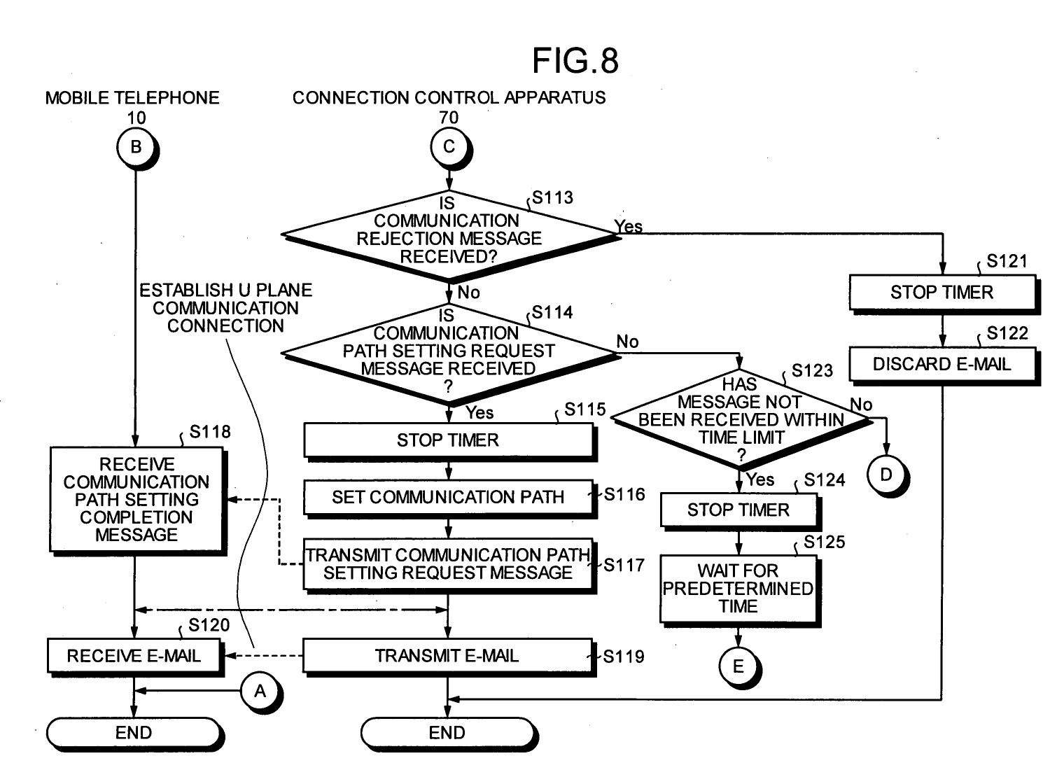

FIGS. 7 and 8 are flowcharts (1) and (2) of sequences of processing to permit/reject e-mail according to the first embodiment.

The user can subscribe to a service for selecting whether to permit or reject e-mails by any given method. In the case of users who have not subscribed to this service, e-mails addressed to the user of the mobile telephone 10 are received by the connection control apparatus 70 and automatically transferred to the mobile telephone 10.

Subscriptions or cancellations of the service can easily be changed by connecting from the mobile telephone 10 to the connection control apparatus 70 and setting a subscriber database. The processing sequences explained below describe a case that the user has subscribed to a service that enables him/her to select whether to permit or reject e-mails.

As shown in FIG. 7, in the permit/reject processing, the e-mail transceiver processor 705 of the connection control apparatus 70 receives an e-mail that is addressed to the user of the mobile telephone 10 (step S101). The e-mail information extracting unit 702 extracts e-mail information, such as the e-mail address of the sender of the e-mail, the mail subject, and an outline of the main text, from the received e-mail (step S102).

The control-information creating unit 703 creates the control information 30 by appending the extracted e-mail information to a reception preparation request message (step S103). In GPRS standards, the reception preparation request message is a request PDP context activation message.

The connection manager 701 transmits the control information 30, created by the control-information creating unit 703, to the mobile telephone 10 via the C plane (step S104). The connection manager 701 then starts timing by using a timer (step S105), in order to determine whether the response control information 40 corresponding to the transmitted control information 30 is received from the mobile telephone 10 within a predetermined time limit, and waits to receive the response control information 40 (step S106).

In GPRS standards, when a request PDP context activation message is transmitted, a time limit of eight seconds is set to receive the response. However, according to the first embodiment, a longer time limit (e.g. 120 seconds) is set, since the user must first consider whether he/she wishes to permit/reject reception of the e-mail.

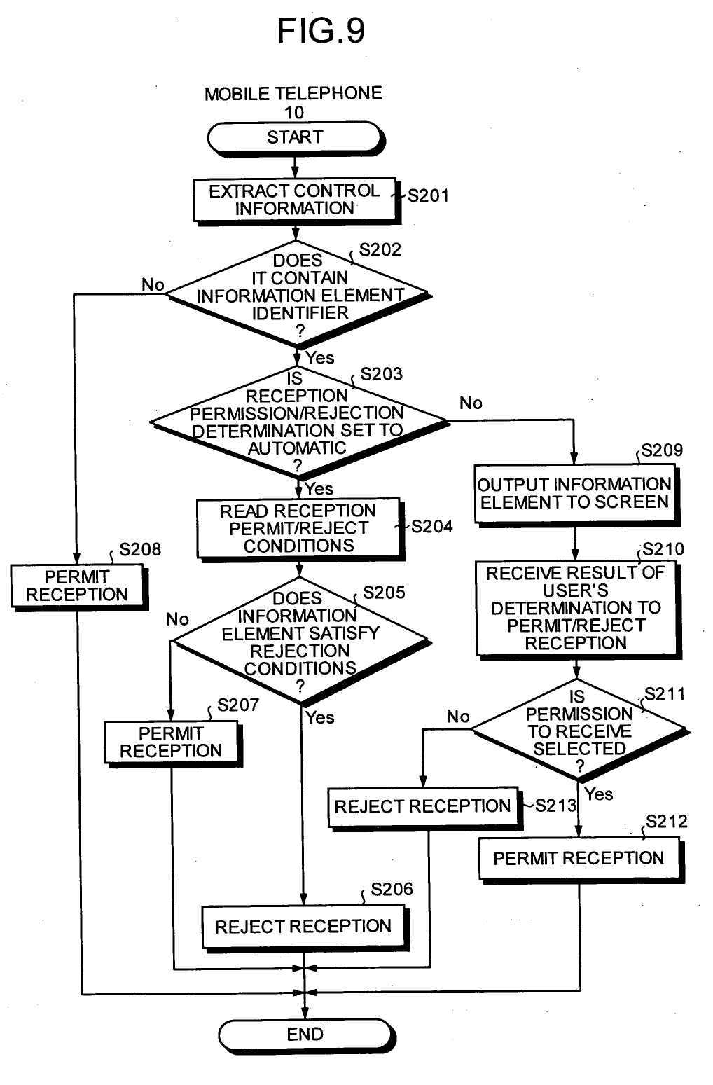

The control information transceiver 109 of the mobile telephone 10 receives the control information 30 from the connection control apparatus 70 (step S107). Based on the e-mail data contained in the control information 30, the reception permit/reject determining unit 110 executes reception permit/reject determination processing to determine whether to permit/reject reception of the e-mail (step S108). The reception permit/reject determination processing will be explained in detail later based on FIG. 9.

The control information transceiver 109 checks whether the reception permit/reject determining unit 110 has determined to permit reception of the e-mail (step S109), and if not (step S109: No), transmits a communication rejection message to the connection control apparatus 70 (step S111), ending the reception permit/reject determination processing on the mobile telephone 10 side. The communication rejection message corresponds to a request PDP context activation request message in GPRS standards.

When the reception permit/reject determining unit 110 determines to permit the e-mail (step S109: Yes), the control information transceiver 109 transmits a communication path setting request message to the connection control apparatus 70 (step S110). The communication path setting request message corresponds to an activate PDP context request message in GPRS standards.

The connection manager 701 of the connection control apparatus 70 receives the response control information 40 (i.e. a communication path setting request message or a communication rejection message) from the mobile telephone 10 (step S112).

As shown in FIG. 8, the transmission permit/reject determining unit 704 of the connection control apparatus 70 determines whether the connection manager 701 has received the communication rejection message from the mobile telephone 10 (step S113).

When the communication rejection message has been received (step S113: Yes), the connection manager 701 stops measuring time using the timer (step S121). The e-mail deletion processor 706 discards the e-mail that corresponds to the received communication rejection message (step S122), and the permit/reject processing ends.

When the communication rejection message has not been received (step S113: No), the transmission permit/reject determining unit 704 determines whether the connection manager 701 has received a communication path setting request message from the mobile telephone 10 (step S114).

When the communication path setting request message has been received (step S114: Yes), the connection manager 701 stops measuring time using the timer (step S115), and sets a communication path to the mobile telephone 10 (step S116).

The connection manager 701 then transmits a communication path setting completion message to the mobile telephone 10 (step S117). In GPRS standards, this communication path setting completion message corresponds to an activate PDP context accept message.

The control information transceiver 109 of the mobile telephone 10 receives the communication path setting completion message from the connection control apparatus 70 (step S118). This establishes a communication connection via the U plane between the mobile telephone 10 and the connection control apparatus 70.

The e-mail transceiver processor 705 of the connection control apparatus 70 transmits the e-mail to the mobile telephone 10 (step S119), ending the permit/reject processing on the connection control apparatus 70 side.

The e-mail manager 108 of the mobile telephone 10 receives the e-mail, transmitted by the e-mail transceiver processor 705 of the connection control apparatus 70 (step S120), ending the permit/reject processing on the mobile telephone 10 side.

In step S114, when the communication path setting request message is not received from the mobile telephone 10 (step S114: No), the connection manager 701 determines whether the response control information 40 is not received within the time limit (step S123). If that is not the case (step S123: No), processing shifts to step S106, and the connection manager 701 continues to wait for the response control information 40 to be received.

When the response control information 40 is not received within the time limit (step S123: Yes), the connection manager 701 stops measuring time using the timer (step S124), and waits for a predetermined time (step S125). Processing then shifts to step S104, and the connection manager 701 retransmits the control information 30 to the mobile telephone 10.

FIG. 9 is a flowchart of the process procedure for the reception permit/reject determination shown in FIG. 7. As shown in FIG. 9, the reception permit/reject determining unit 110 of the mobile telephone 10 extracts the control information 30 received from the connection control apparatus 70 (step S201).

The reception permit/reject determining unit 110 determines whether the control information 30 contains an information element identifier (step S202), and if not (step S202: No), permits reception of the e-mail (step S208), whereby the reception permit/reject determination processing ends.

When the control information 30 contains an information element identifier (step S202: Yes), the reception permit/reject determining unit 110 determines whether reception permit/reject determination is set to be performed automatically (step S203).

When reception permit/reject determination is set to be performed automatically (step S203: Yes), the reception permit/reject determining unit 110 reads the reception permit/reject determining conditions 107d from the storage unit 107 (step S204), and determines whether the information element in the control information 30 satisfies the rejection conditions stored in the reception permit/reject determining conditions 107d (step S205).

When the information element satisfies the rejection conditions (step S205: Yes), the reception permit/reject determining unit 110 rejects reception of the e-mail (step S206), and the permit/reject determination processing ends.

When the information element does not satisfy the rejection conditions (step S205: No), the reception permit/reject determining unit 110 permits reception of the e-mail (step S207), and the permit/reject determination processing ends.

In step S203, when reception permit/reject determination is not set to be performed automatically (step S203: No), the reception permit/reject determining unit 110 outputs information elements, such as the e-mail address of the sender, to the screen as shown in FIG. 6 (step S209), and receives a selection, input by the user, of whether to permit or reject reception of the e-mail (step S210).

The reception permit/reject determining unit 110 then determines whether the user has selected to permit reception (step S211), and if so (step S211: Yes), permits reception of the e-mail (step S212), ending the permit/reject determination processing. When the user has not selected to permit reception (step S211: No), the reception permit/reject determining unit 110 rejects the e-mail (step S213), ending the permit/reject determination processing.

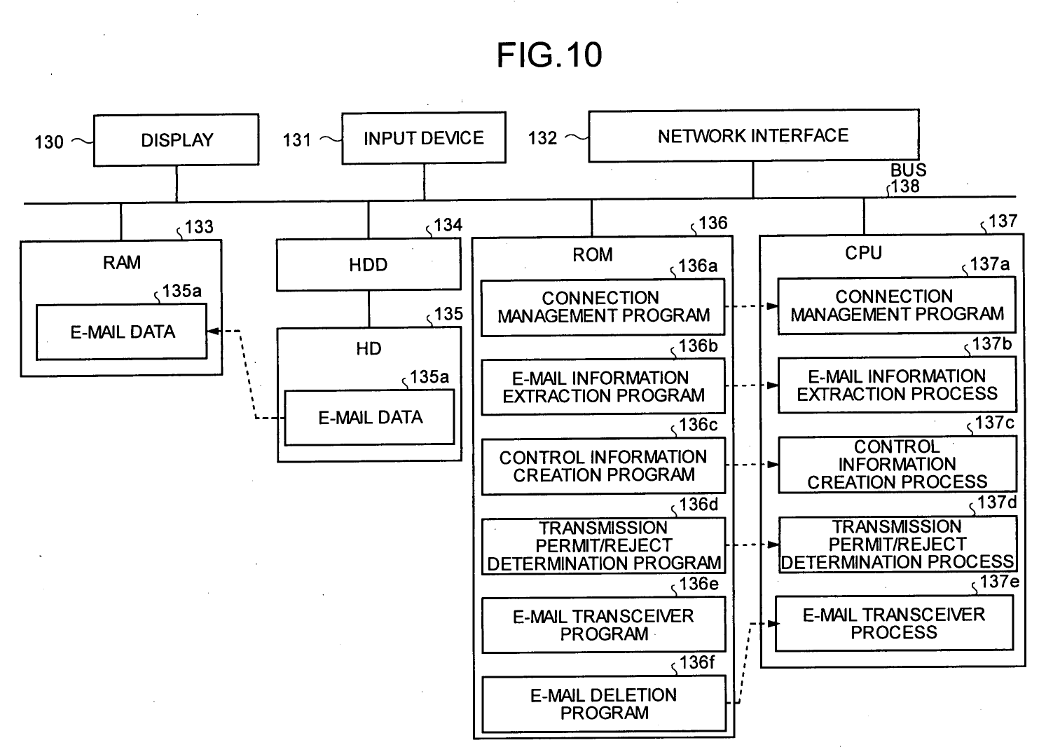

FIG. 10 is a diagram of the hardware constitution of the connection control apparatus 70 shown in FIG. 2. As shown in FIG. 10, the connection control apparatus 70 includes a display 130, an input device 131, a network interface 132, a random access memory (RAM) 133, a hard disk drive (HDD) 134, a hard disk (HD) 135, a read-only memory (ROM) 136, and a central processing unit (CPU) 137, these being connected by a bus 138.

The display 130 is a display apparatus that outputs various types of information. The input device 131 includes a keyboard, a mouse, and such like. The network interface 132 transmits/receives data to/from the radio base station controller 60 and the gateway apparatus 80.

The HD 135 is a storage medium that stores data, storing and reading of the data being controlled by the HDD 134. E-mails addressed to the user of the mobile telephone 10, and e-mails transmitted from the mobile telephone 10, are stored on the HD 135 as e-mail data 135a. The e-mail data 135a corresponds to the address book data 107a.

Corresponding to a reference request from the CPU 137, which controls the connection control apparatus 70 and performs operations, the e-mail data 135a is read to the RAM 133, comprising a storage device that is volatile when necessary, and is referred to by the CPU 137.

The ROM 136 is a nonvolatile storage device, in which a connection management program 136a, an e-mail information extraction program 136b, a control information creation program 136c, a transmission permit/reject determination program 136d, an e-mail transceiver program 136e, and an e-mail deletion program 136f, are stored beforehand.

The programs 136a to 136f are read and executed by the CPU 137 when necessary, whereby they become a connection management process 137a, an e-mail information extraction process 137b, a control information creation process 137c, a transmission permit/reject determination process 137d, an e-mail transceiver process 137e, and an e-mail deletion process 137f.

The connection management process 137a corresponds to the connection manager 701 of FIG. 2, the e-mail information extraction process 137b corresponds to the e-mail information extracting unit 702 of FIG. 2, the control information creation process 137c corresponds to the control-information creating unit 703 of FIG. 2, the transmission permit/reject determination process 137d corresponds to the transmission permit/reject determining unit 704 of FIG. 2, and the e-mail transceiver process 137e corresponds to the e-mail deletion processor 706 of FIG. 2.

FIG. 10 is an example of an e-mail being rejected. Accordingly, the CPU 137 does not read the e-mail transceiver program 136e that transmits the e-mail to the mobile telephone 10.

When reception of an e-mail has been permitted, the CPU 137 reads and executes the e-mail transceiver program 136e, whereby it becomes an e-mail transceiver process. The e-mail transceiver process corresponds to the e-mail transceiver processor 705 of FIG. 2.

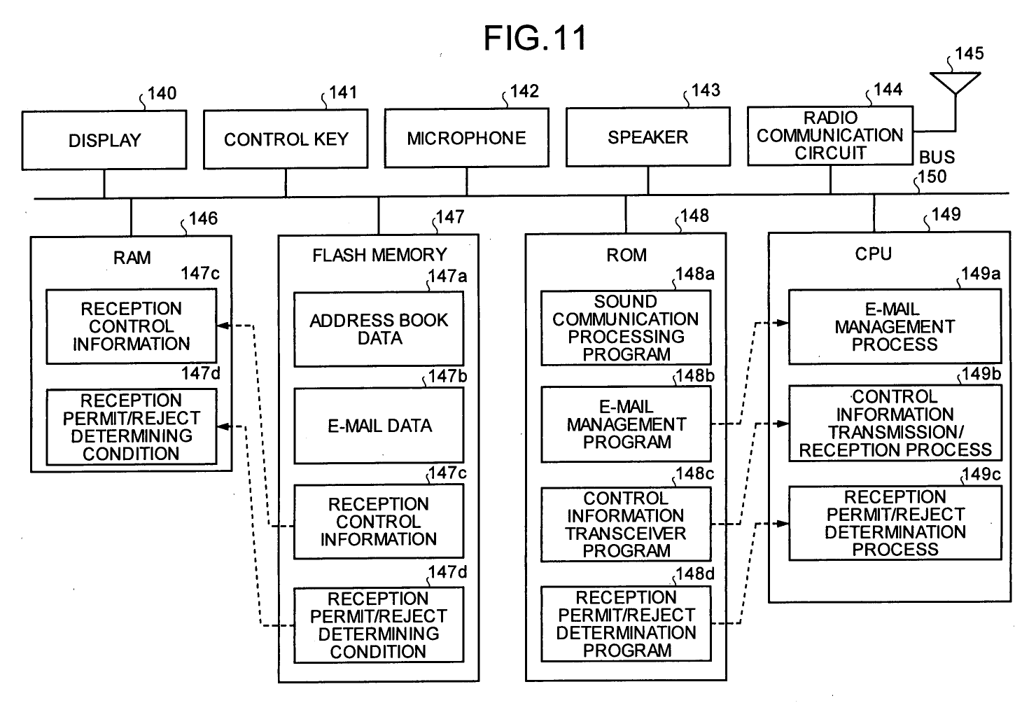

FIG. 11 is a diagram of the hardware constitution of the mobile telephone 10 shown in FIG. 4. As shown in FIG. 11, the mobile telephone 10 includes a display 140, control keys 141, a microphone 142, a speaker 143, a radio communication circuit 144, an antenna 145, a RAM 146, a flash memory 147, a ROM 148, and a CPU 149, these being connected by a bus 150.

The display 140, the control keys 141, the microphone 142, the speaker 143, the radio communication circuit 144, and the antenna 145 respectively correspond to the display 103, the control keys 102, the microphone 104, the speaker 105, the radio communication processor 101, and the antenna 100, shown in FIG. 4.

The flash memory 147 is a semiconductor memory capable of reading/writing data, and stores address book data 147a, e-mail data 147b, reception control information 147c, and reception permit/reject determining conditions 147d.

The address book data 147a, the e-mail data 147b, the reception control information 147c, and the reception permit/reject determining conditions 147d respectively correspond to the address book data 107a, the e-mail data 107b, the reception control information 107c, and the reception permit/reject determining conditions 107d, shown in FIG. 2.

Corresponding to a reference request from the CPU 149, which controls the mobile telephone 10 and performs operations, the address book data 147a, the e-mail data 147b, the reception control information 147c, and the reception permit/reject determining conditions 147d are read to the RAM 146 when necessary and referred to by the CPU 149.

A sound communication processing program 148a, an e-mail management program 148b, a control information transceiver program 148c, and a reception permit/reject determination program 148d, are stored beforehand in the ROM 148.

The CPU 149 reads and executes the programs 148a to 148d when necessary, whereby they become an e-mail management process 149a, a control information transmission/reception process 149b, a reception permit/reject determination process 149c, and the like.

The e-mail management process 149a corresponds to the e-mail manager 108 of FIG. 4, the control information transmission/reception process 149b corresponds to the control information transceiver 109 of FIG. 4, and the reception permit/reject determination process 149c corresponds to the reception permit/reject determining unit 110 of FIG. 4.

FIG. 11 is an example of a case that the mobile telephone 10 determines whether to permit/reject the e-mail. Accordingly, the CPU 149 does not read the sound communication processing program 148a that executes sound communication processing.

When executing sound communication processing, the CPU 149 reads and executes the sound communication processing program 148a, which becomes a sound communication processing process. The sound communication processing process corresponds to the sound processor 106 of FIG. 4.

As described above, according to the first embodiment, the control-information creating unit 703 of the connection control apparatus 70 creates the control information 30 containing e-mail information, and the connection manager 701 transmits the created control information 30. The control information transceiver 109 of the mobile telephone 10 receives the control information 30 that contains the e-mail information from the connection control apparatus 70. When it has been determined to permit reception of the e-mail, based on the e-mail information contained in the received control information 30, the control information transceiver 109 transmits the response control information 40 containing a communication path setting request message to the connection control apparatus 70. When it has been determined to reject reception of the e-mail, the control information transceiver 109 transmits the response control information 40 containing a communication rejection message to the connection control apparatus 70. Consequently, the user can select whether to permit or reject reception of e-mails, which are addressed to him/her and have been transmitted to his mobile telephone 10, without incurring communication fees.

According to the first embodiment, the user determines whether to permit or reject reception of the e-mail based the e-mail information contained in the received control information 30, and inputs the result of his determination to the reception permit/reject determining unit 110 of the mobile telephone 10. When the user determines to permit the e-mail, the control information transceiver 109 transmits a communication path setting request message as the response control information 40 to the connection control apparatus 70. When the user determines to reject the e-mail, the control information transceiver 109 transmits the communication rejection message as the response control information 40 to the connection control apparatus 70. This enables the user of the mobile telephone 10 to select whether to permit or reject reception of e-mails addressed to him/her, by inputting his selection to permit/reject them.

According to the first embodiment, the reception permit/reject determining unit 110 of the mobile telephone 10 determines whether to permit reception of an e-mail based on e-mail information contained in the received control information 30. When it is determined to permit the e-mail, the response control information 40 containing a communication path setting request message is transmitted to the connection control apparatus 70. When it is determined to reject the e-mail, the response control information 40 containing a communication rejection message is transmitted to the connection control apparatus 70. Therefore, it is possible to automatically determine whether to permit/reject reception of e-mails addressed to the user of the mobile telephone 10.

According to the first embodiment, the e-mail information includes the e-mail address of the sender, a mail subject, and an outline of the main text of the mail. This enables the user of the mobile telephone 10 to efficiently select whether to permit/reject e-mails addressed to him/her, based on the e-mail address of the sender, the mail subject, and the outline of the main text of the mail.

According to the first embodiment, while the connection control apparatus 70 receives the response control information 40, indicating the result of the determination whether to permit/reject, each time it transmits the control information 30 containing the e-mail information to the mobile telephone 10, the mobile telephone 10 may save a plurality of control information 30, received from the connection control apparatus 70, and transmit the response control information 40 corresponding to each control information 30 at any given time to the connection control apparatus 70.

The connection control apparatus 70 determines whether the response control information 40 is a communication path setting request message or a communication rejection message. When it is a communication path setting request message, the connection control apparatus 70 sets a communication path to the mobile telephone 10 and transmits an e-mail that corresponds to the communication path setting request message to the mobile telephone 10. When the response control information 40 is a communication rejection message, the connection control apparatus 70 discards the e-mail that corresponds to the communication rejection message.

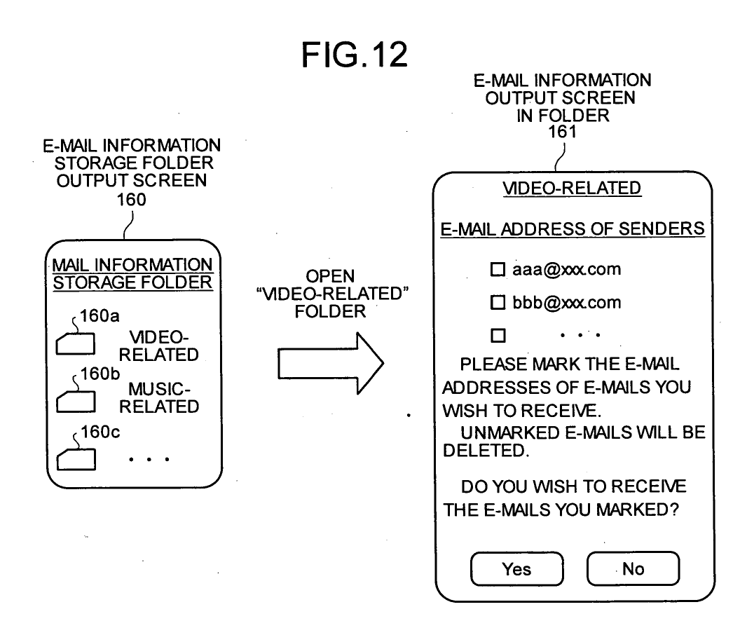

FIG. 12 is an example of an e-mail information output screen that is output when saving the control information 30. As shown in an e-mail information storage folder output screen 160 of FIG. 12, when saving the control information 30, the e-mail information extracted from the control information 30 is stored in predetermined folders 160a to 160c.

In the example of FIG. 12, the e-mail information is categorized and stored in a plurality of folders, such as “video-related”, “music-related”, and the like. Categories are determined by, for example, using information in the outline of the main text, contained in the e-mail information.

Keywords are stored beforehand in correspondence with categories such as “video-related” and “music-related”, and, when the mail subject or main text outline contains these keywords, the e-mail information is stored in the folder of the category that corresponds to each keyword.

The e-mail information output screen 161 in a folder is output by specifying the folder and opening it. The e-mail information contained in the saved control information 30 is output to the e-mail information output screen 161 in the folder.

In the example of FIG. 12, the “video-related” folder is open, and e-mail information showing the e-mail address of the sender is being output. This enables the user of the mobile telephone 10 to select the e-mail information of the e-mail he/she wishes to permit.

When the user has selected the e-mail information of the e-mail that he/she wishes to permit, the mobile telephone 10 transmits a communication path setting request message for receiving the e-mail to the connection control apparatus 70. The mobile telephone 10 also transmits a communication rejection message for rejecting all other e-mails to the connection control apparatus 70.

While in this example the connection control apparatus 70 transmits one control information 30 for each e-mail addressed to the user of the mobile telephone 10, and the mobile telephone 10 transmits a piece of response control information 40 corresponding to each control information 30, when the connection control apparatus 70 has received a plurality of e-mails addressed to the user of the mobile telephone 10, it may create one control information that contains e-mail information for the plurality of e-mails and transmit the created control information to the mobile telephone 10.

When the mobile telephone 10 is saving a plurality of control information 30, it is acceptable to create a piece of response control information that contains a plurality of permit/reject information corresponding to the plurality of control information 30, and transmit the created response control information to the connection control apparatus 70.

According to the first embodiment, the radio communication system 20 transmits the control information 30 containing the e-mail information to the mobile telephone 10, and the mobile telephone 10 determines whether to permit/reject reception of the e-mail based on the e-mail information. However, the mobile telephone may transmit beforehand control information, which contains e-mail information rejecting the reception, to the radio communication system, and, when the radio communication system receives an e-mail addressed to the user of the mobile telephone, it determines whether to permit/reject transmission of the e-mail to the mobile telephone.

According to a second embodiment of the present invention, the mobile telephone transmits beforehand control information, which contains e-mail rejecting the reception, to the radio communication system, and the radio communication system determines whether to permit/reject transmission of the e-mail to the mobile telephone based on the transmitted e-mail information.

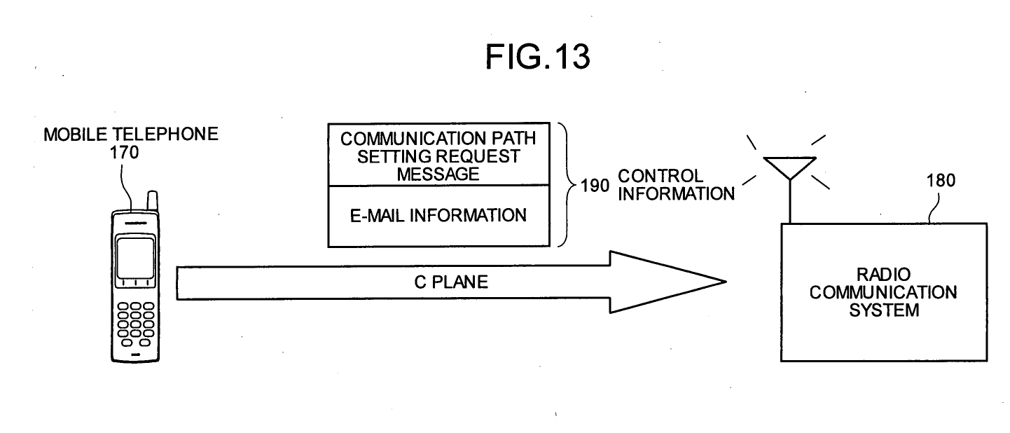

FIG. 13 is a diagram of the concept of permit/reject selection processing of e-mails according to the second embodiment. As shown in FIG. 13, in the permit/reject selection processing, a mobile telephone 170 transmits control information 190, which contains e-mail information rejecting reception, to the radio communication system 180 via the C plane.

Specifically, the mobile telephone 170 creates the control information 190 by appending e-mail information that rejects reception to a communication path setting request message, and transmits the created control information 190 to the radio communication system 180.

The communication path setting request message corresponds to an activate PDP context request message in GPRS standards, and includes control information that, when the mobile telephone 170 transmits an e-mail, is transmitted prior to transmitting the e-mail in order to set a communication path for it.

The e-mail information in the control information 190 includes, for example, information such as the e-mail address of the sender of the e-mail being rejected, a mail subject of the e-mail being rejected, and the like.

The radio communication system 180 extracts the e-mail information of an e-mail that is to be rejected from the control information 190 transmitted from the mobile telephone 170, and stores it. When the radio communication system 180 receives an e-mail addressed to the user of the mobile telephone 170, it refers to the stored e-mail information, and determines whether to transmit the e-mail to the mobile telephone 170.

Specifically, the radio communication system 180 determines whether the e-mail address of the sender of the received e-mail matches the e-mail address of the sender of the e-mail to be rejected, and whether the mail subject of the received e-mail matches the mail subject of the e-mail to be rejected. Based on the result of this determination, the radio communication system 180 transmits or discards the e-mail.

Since the user of the mobile telephone 170 sends the control information 190 containing information relating to e-mails to be rejected to the radio communication system 180 in this way, he/she can notify the radio communication system 180 of the e-mail information relating to e-mails to be rejected without incurring communication fees.

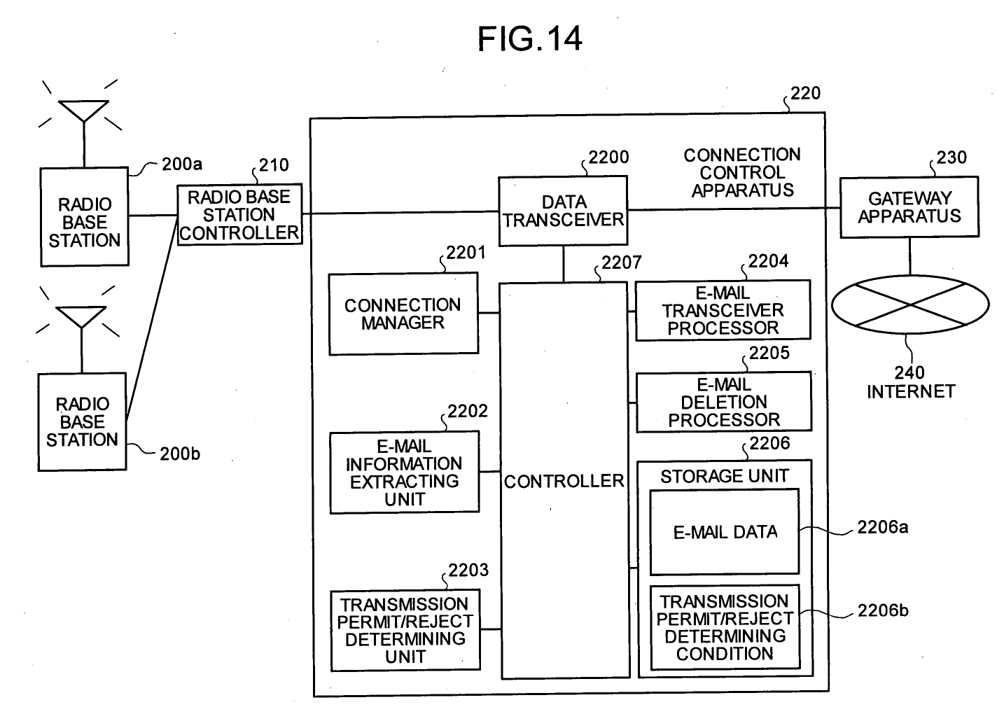

FIG. 14 is a function block diagram of the functional constitution of the radio communication system 180 shown in FIG. 13. As shown in FIG. 14, the radio communication system 180 includes radio base stations 200a and 220b, a radio base station controller 210, a connection control apparatus 220, and a gateway apparatus 230.

The radio base stations 200a and 200b, the radio base station controller 210, and the gateway apparatus 230, have the same functions as the radio base stations 50a and 50b, the radio base station controller 60, and the gateway apparatus 80, shown in FIG. 2.

The connection control apparatus 220 exchanges control information with the mobile telephone 170, establishes and cuts off communications and the like, and receives/transmits e-mails to/from the mobile telephone 170.

The connection control apparatus 220 not only controls communication connections and receives/transmits e-mails, but also transmits control information 190 containing the e-mail information via the C plane to the mobile telephone 170.

When the connection control apparatus 220 receives an e-mail addressed to the user of the mobile telephone 170, it refers to the e-mail information, which is received beforehand from the mobile telephone 170, determines whether to transmit the e-mail to the mobile telephone 170, and transmits or discards the e-mail based on the result of that determination.

The connection control apparatus 220 includes a data transceiver 2200, a connection manager 2201, an e-mail information extracting unit 2202, a transmission permit/reject determining unit 2203, an e-mail transceiver processor 2204, an e-mail deletion processor 2205, a storage unit 2206, and a controller 2207.

The data transceiver 2200 has the same functions as the data transceiver 700 shown in FIG. 2. The connection manager 2201 controls communication connection by exchanging control information for establishing and cutting off communication connection with the mobile telephone 170. The connection manager 2201 receives from the mobile telephone 170 the control information 190 containing e-mail information of e-mails that are to be rejected.

When the connection manager 2201 receives the control information 190, the e-mail information extracting unit 2202 extracts e-mail information, such as the e-mail address of the sender of the e-mail to be rejected, its mail subject, and the like, from the control information 190, and stores this information in the storage unit 2206 as transmission permit/reject determining conditions 2206b.

When an e-mail addressed to the user of the mobile telephone 170 is received, the transmission permit/reject determining unit 2203 refers to the transmission permit/reject determining conditions 2206b stored in the storage unit 2206. The transmission permit/reject determining unit 2203 then determines whether the e-mail address of the sender of the received e-mail matches the e-mail address of the sender of the e-mail to be rejected, and whether the mail subject of the received e-mail matches the mail subject of the e-mail to be rejected.

When the e-mail address of the sender of the received e-mail matches the e-mail address of the sender of the e-mail to be rejected, or when the mail subject of the received e-mail matches the mail subject of the e-mail to be rejected, the transmission permit/reject determining unit 2203 determines to delete the e-mail, and request the e-mail deletion processor 2205 to delete it.

In all cases other than the above, the transmission permit/reject determining unit 2203 determines to transmit the e-mail to the mobile telephone 170, and requests the e-mail transceiver processor 2204 to transmit it.

The e-mail transceiver processor 2204 receives e-mails from the mobile telephone 170, and transfers them to the gateway apparatus 230. The e-mail transceiver processor 2204 also receives e-mails via the Internet, and stores them in the storage unit 2206.

When the transmission permit/reject determining unit 2203 requests the e-mail transceiver processor 2204 to send an e-mail to the mobile telephone 170, the e-mail transceiver processor 2204 reads the data of the e-mail from the storage unit 2206 and transmits it to the mobile telephone 170.

When the transmission permit/reject determining unit 2203 requests that an e-mail be deleted, the e-mail deletion processor 2205 deletes the data of the e-mail from the storage unit 2206.

The storage unit 2206 is a storage device, such as a hard disk apparatus. The storage unit 2206 stores e-mail data 2206a and the transmission permit/reject determining conditions 2206b. The e-mail data 2206a is data of e-mails addressed to the user of the mobile telephone 170, and e-mails transmitted from the mobile telephone 170.

The transmission permit/reject determining conditions 2206b are e-mail information, contained in the control information 190 that is transmitted by the mobile telephone 170, and include information relating to e-mails that the mobile telephone 170 rejects to receive, namely, the e-mail address of the sender of the e-mail to be rejected and its mail subject. The controller 2207 controls the entire connection control apparatus 220, overseeing the exchange of data between its functional units, and the like.

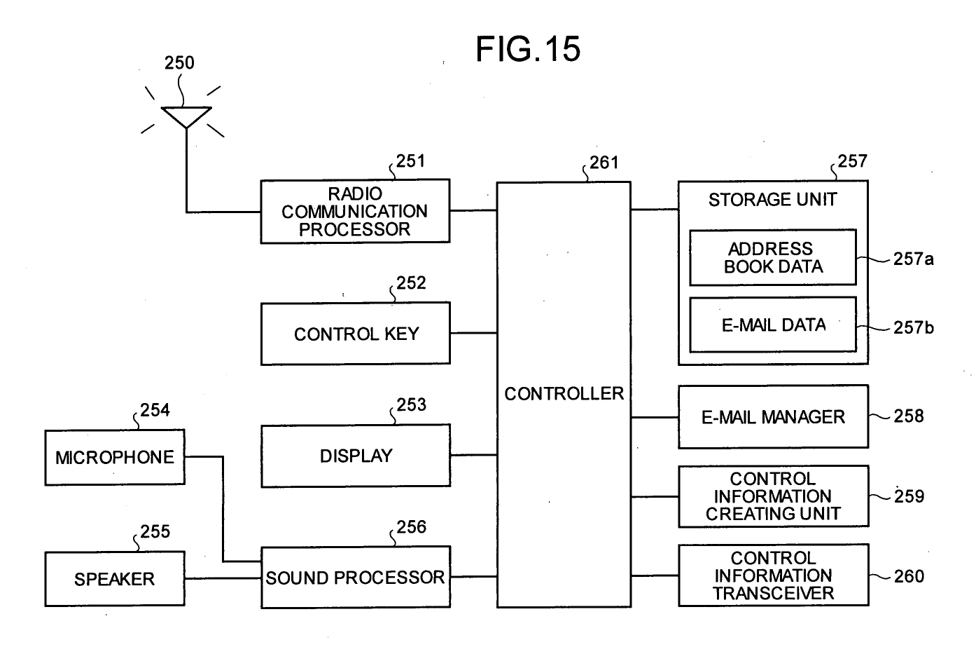

FIG. 15 is a diagram of the functional constitution of the mobile telephone 170 shown in FIG. 13. As shown in FIG. 15, the mobile telephone 170 includes an antenna 250, a radio communication processor 251, control keys 252, a display 253, a microphone 254, a speaker 255, a sound processor 256, a storage unit 257, an e-mail manager 258, a control-information creating unit 259, a control information transceiver 260, and a controller 261.

The antenna 250, the radio communication processor 251, the control keys 252, the display 253, the microphone 254, the speaker 255, and the sound processor 256, have the same functions as the antenna 100, the radio communication processor 101, the control keys 102, the display 103, the microphone 104, the speaker 105, and the sound processor 106, shown in FIG. 4.

The storage unit 257 is a storage device such as a flash memory. The storage unit 257 stores address book data 257a and e-mail data 257b, which respectively correspond to the address book data 107a and the e-mail data 107b shown in FIG. 4.

The e-mail manager 258 has the same functions as the e-mail manager 108 shown in FIG. 4. The control-information creating unit 259 creates new control information 190 by appending e-mail information to the control information for requesting the connection control apparatus 220 to set a communication path.

The user inputs the mail subjects and e-mail addresses of senders whose e-mails he/she wishes to reject to the control-information creating unit 259, and the control-information creating unit 259 creates the control information 190 by appending this information to a communication path setting request message.

The control information transceiver 260 transmits/receives control information relating to communication control to/from the connection control apparatus 220. Particularly, when the control-information creating unit 259 has created control information 190 that contains e-mail information of an e-mail that is to be rejected, the control information transceiver 260 transmits the control information 190 to the connection control apparatus 220.

The connection control apparatus 220 receives the control information 190, and stores it as a transmission permit/reject determination condition 2206b. When the connection control apparatus 220 receives an e-mail addressed to the user of the mobile telephone 170, it determines whether to transmit the e-mail to the mobile telephone 170 based on the transmission permit/reject determination condition 2206b.

The hardware constitution of the connection control apparatus 220 is approximately the same as that of the connection control apparatus 70 according to the first embodiment shown in FIG. 10, a difference being that the connection control apparatus 220 stores the e-mail data 2206a and the transmission permit/reject determining conditions 2206b on the HD, which is read by the RAM and referred to by the CPU of the connection control apparatus 220, corresponding to a reference request from the CPU.

A connection management program, an e-mail information extraction program, a transmission permit/reject determination program, an e-mail transceiver program, and an e-mail deletion program, are stored beforehand in the ROM, and are read and executed by the CPU when necessary, whereby they become a connection management process, an e-mail information extraction process, a transmission permit/reject determination process, an e-mail transceiver process, and an e-mail deletion process.

The connection management process corresponds to the connection manager 2201 of FIG. 14, the e-mail information extraction process corresponds to the e-mail information extracting unit 2202 of FIG. 14, the transmission permit/reject determination process corresponds to the transmission permit/reject determining unit 2203 of FIG. 14, the e-mail transceiver process corresponds to the e-mail transceiver processor 2204 of FIG. 14, and the e-mail deletion process corresponds to the e-mail deletion processor 2205 of FIG. 14.

The hardware constitution of the mobile telephone 170 is approximately the same as that of the mobile telephone 10 according to the first embodiment shown in FIG. 11, a difference being that the mobile telephone 170 stores address book data 257a and e-mail data 257b in the flash memory, which is read by the RAM and referred to by the CPU of the mobile telephone 170, corresponding to a reference request from the CPU.

A sound processing program, an e-mail management program, a control information creation program, and a control information transceiver program, are stored beforehand in the ROM, and are read and executed by the CPU when necessary, whereby they become a sound processing process, an e-mail management process, a control information creation process, and a control information transceiver process.

The sound processing process corresponds to the sound processor 256 of FIG. 15, the e-mail management process corresponds to the e-mail manager 258 of FIG. 15, the control information creation process corresponds to the control-information creating unit 259 of FIG. 15, and the control information transceiver process corresponds to the control information transceiver 260 of FIG. 15.

While the second embodiment transmits e-mail information of e-mails that are to be rejected in the control information 190, the present invention is not restricted to this, and e-mail information of e-mails that are to be permitted may be transmitted instead.

As described above according to the second embodiment, the control-information creating unit 259 of the mobile telephone 170 creates the control information 190, containing e-mail information of e-mails that are to be rejected or permitted, the control information transceiver 260 transmits the created control information 190 to the connection control apparatus 220, and the transmission permit/reject determining unit 2203 of the connection control apparatus 220 determines whether to permit reception of an e-mail by the mobile telephone 170 based on the e-mail information of e-mails that are to be rejected or permitted contained in the control information 190. Therefore, the user of the mobile telephone 170 can select whether to permit or reject e-mails addressed to him/her without incurring communication fees.

While exemplary embodiments of the present invention have been explained so far, embodiments other than the above-described ones may also be implemented, within the technical sprit of the appended claims.

While the embodiments describe an example of a mobile telephone as the communication terminal that receives e-mails, the present invention is not restricted to this, and may also be applied in a personal digital assistant (PDA), a personal handy-phone system (PHS), and the like, which have functions for transmitting and receiving e-mails, and control data communication of the e-mails by transmitting and receiving control information.

Among the respective processing explained in the embodiments, all or a part of the processing explained as being performed automatically may be performed manually, or all or a part of the processing explained as being performed manually may be performed automatically in a known method.

The information including the processing procedure, the control procedure, specific names, and various kinds of data and parameters shown in the specification or in the drawings can be optionally changed, unless otherwise specified.

The respective constituent elements of the apparatus shown in the drawings are functionally conceptual, and the physically same configuration is not always necessary. In other words, the specific mode of dispersion and integration of the apparatus is not limited to the ones shown in the drawings, and all or a part thereof may be functionally or physically dispersed or integrated in an optional unit, according to the various kinds of load and the status of use.

All or an optional part of the various processing functions performed by each apparatus can be realized by the CPU or a program analyzed and executed by the CPU, or can be realized as hardware by the wired logic. According to the present invention, first control information contains information relating to an e-mail appended to control information relating to a reception preparation request for an e-mail, and is received from a mail server. When it is determined to permit reception of the e-mail, based on the information relating to the e-mail contained in the received first control information, second control information relating to a communication path setting request is transmitted to the mail server. When it is determined to reject reception of the e-mail, third control information relating to a communication rejection is transmitted to the mail server. Therefore, a user of the communication terminal can selected whether to permit/reject reception of an e-mail that is addressed to him/her, without incurring communication fees.

According to the present invention, the user inputs a result of his determination whether to permit reception of an e-mail, made based on the information relating to the e-mail contained in the received first control information. When it is determined to permit reception of the e-mail, second control information, which relates to a communication path setting request, is transmitted to the mail server. When it is determined to reject reception of the e-mail, third control information, which relates to a communication rejection, is transmitted to the mail server. Since the user of the communication terminal inputs the determination whether to permit/reject e-mails, he/she can select whether to permit/reject e-mails addressed to him/her.

According to the present invention, it is determined whether to permit reception of an e-mail based on information relating to the e-mail, which is contained in the received first control information. When it is determined to permit reception of the e-mail, second control information relating to a communication path setting request is transmitted to the mail server. When it is determined to reject reception of the e-mail, third control information relating to a communication rejection is transmitted to the mail server. This makes it possible to determine automatically whether to permit or reject reception of e-mails that are addressed to the user of the cash memory apparatus.

According to the present invention, control information containing information that relates to an e-mail to be permitted, or information that relates to an e-mail to be rejected, is created and transmitted to the mail server. This enables information relating to e-mails to be transmitted to the mail server, which determines whether to permit/reject the e-mails, without incurring communication fees, and enables the user of the mail server to select whether to permit/reject e-mails addressed to him/her.

According to the present invention, first control information, which contains information relating to a reception preparation request of an e-mail and information relating to the e-mail, is created and transmitted. The transmitted first control information is received from a mail server. When it is determined to permit reception of the e-mail based on the information relating to it contained in the received first control information, second control information relating to a communication path setting request is transmitted to the mail server. When it is determined to reject reception of the e-mail, third control information relating to a communication rejection is transmitted to the mail server. This enables the user of the communication terminal to select whether to permit/reject e-mails that are addressed to him/her, without incurring communication fees.

According to the present invention, control information containing information that relates to e-mails to be permitted, or information that relates to e-mails to be rejected, is created and transmitted to the mail server. The mail server determines whether to transmit an e-mail to the communication terminal based on the information that relates to e-mails to be permitted, or the information that relates to e-mails to be rejected. This enables the user of the communication terminal to select whether to permit/reject reception of e-mails that are addressed to him/her, without incurring communication fees.

According to the present invention, the information relating to the e-mail includes the e-mail address of its sender, the title of the e-mail, and an outline of the main text of the e-mail. This enables the user of the communication terminal to efficiently select whether to permit/reject reception of e-mails based on information relating to the e-mail address of its sender, its title, and the outline of its main text.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A communication terminal that, upon receiving first control information relating to a request for preparing a reception of an e-mail from a mail server, transmits second control information relating to a request for setting a communication path to the mail server, and receives the e-mail via the communication path set by the mail server, the communication terminal comprising:
a control-information receiving unit that receives the first control information from the mail server, the first control information including information relating to the e-mail; and
a control-information transmitting unit that transmits either of the second control information and third control information relating to a rejection of communication to the mail server, wherein
when it is determined to permit the reception of the e-mail based on the information relating to the e-mail, the control-information transmitting unit transmits the second control information to the mail server, and
when it is determined to reject the reception of the e-mail the control-information transmitting unit transmits the third control information to the mail server.

2. The communication terminal according to claim 1, wherein the control-information transmitting unit receives an input of a result of determination whether to permit the reception of the e-mail based on the information relating to the e-mail from a user,
when the result of determination is to permit the reception of the e-mail, the control-information transmitting unit transmits the second control information to the mail server, and
when the result of determination is to reject the reception of the e-mail, the control-information transmitting unit transmits the third control information to the mail server.

3. The communication terminal according to claim 1, wherein
the control-information transmitting unit determines whether to permit the reception of the e-mail based on the information relating to the e-mail,
when a determination is to permit the reception of the e-mail, control-information transmitting unit transmits the second control information to the mail server, and
when the determination is to reject reception of the e-mail, control-information transmitting unit transmits the third control information to the mail server.

4. The communication terminal according to claim 1, wherein the information relating to the e-mail includes information relating to an e-mail address of a sender, a title of the e-mail, and an outline of a main body of the e-mail.

5. A communication terminal that transmits control information relating to a request for setting a communication path to a mail server that determines whether to permit a transmission of an e-mail, and transmits the e-mail via the communication path set by the mail server, the communication terminal comprising:
a control-information creating unit that creates the control information including either of information relating to an e-mail to be permitted and information relating to an e-mail to be rejected; and
a control-information transmitting unit that transmits the control information created to the mail server.

6. A communication method of, upon receiving first control information relating to a request for preparing a reception of an e-mail from a mail server, transmitting second control information relating to a communication path setting request to the mail server,-and receiving the e-mail via the communication path set by the mail server, the communication method comprising:
creating the first control information including information relating to the e-mail at the mail server;
transmitting the first control information created from the mail server;
receiving the first control information from the mail server; and
transmitting either of the second control information and third control information relating to a rejection of communication to the mail server, wherein
when it is determined to permit the reception of the e-mail based on the information relating to the e-mail, the transmitting either of the second control information and third control information includes transmitting the second control information to the mail server, and
when it is determined to reject the reception of the e-mail the control-information transmitting unit the transmitting either of the second control information and third control information includes transmitting the third control information to the mail server.

7. The communication method according to claim 6, wherein
the transmitting either of the second control information and third control information includes receiving an input of a result of determination whether to permit the reception of the e-mail based on the information relating to the e-mail from a user,
when the result of determination is to permit the reception of the e-mail, the transmitting either of the second control information and third control information includes transmitting the second control information to the mail server, and
when the result of determination is to reject the reception of the e-mail, the transmitting either of the second control information and third control information includes transmitting the third control information to the mail server.

8. The communication method according to claim 6, wherein
the transmitting either of the second control information and third control information further includes determining whether to permit the reception of the e-mail based on the information relating to the e-mail,
when a determination is to permit the reception of the e-mail, the transmitting either of the second control information and third control information includes transmitting the second control information to the mail server, and
when the determination is to reject the reception of the e-mail, the transmitting either of the second control information and third control information includes transmitting the third control information to the mail server.

9. The communication method according to claim 6, wherein the information relating to the e-mail includes information relating to an e-mail address of a sender, a title of the e-mail, and an outline of a main body of the e-mail.

10. A communication method of, when a communication terminal transmits control information relating to a request for setting a communication path to a mail server that determines whether to permit a transmission of an e-mail, transmitting the e-mail via the communication path set by the mail server, the communication method comprising:
creating the control information including either of information relating to an e-mail to be permitted and information relating to an e-mail to be rejected;
transmitting the control information created to the mail server; and
determining whether to permit a transmission of the e-mail to the communication terminal based on either of the information relating to the e-mail to be permitted and the information relating to the e-mail to be rejected.

11. A computer-readable recording medium that stores a communication program for, upon receiving first control information relating to a request for preparing a reception of an e-mail from a mail server, transmitting second control information relating to a communication path setting request to the mail server, and receiving the e-mail via the communication path set by the mail server, wherein the communication program makes a computer execute
creating the first control information including information relating to the e-mail at the mail server;
transmitting the first control information created from the mail server;
receiving the first control information from the mail server; and
transmitting either of the second control information and third control information relating to a rejection of communication to the mail server, wherein
when it is determined to permit the reception of the e-mail based on the information relating to the e-mail, the transmitting either of the second control information and third control information includes transmitting the second control information to the mail server, and
when it is determined to reject the reception of the e-mail the control-information transmitting unit the transmitting either of the second control information and third control information includes transmitting the third control information to the mail server.

12. A computer-readable recording medium that stores a communication program for, when a communication terminal transmits control information relating to a request for setting a communication path to a mail server that determines whether to permit a transmission of an e-mail, transmitting the e-mail via the communication path set by the mail server, wherein the communication program makes a computer execute
creating the control information including either of information relating to an e-mail to be permitted and information relating to an e-mail to be rejected;
transmitting the control information created to the mail server; and
determining whether to permit a transmission of the e-mail to the communication terminal based on either of the information relating to the e-mail to be permitted and the information relating to the e-mail to be rejected.
